(19) United States
(12) Patent Application Publication
(10) Pub. No.: US 2003/0149776 A1
(43) Pub. Date: Aug. 7, 2003

(54) Terminal information management method

(75) Inventor: Tomoko Tsunezumi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/259,505

(22) Filed: Sep. 30, 2002

(30) Foreign Application Priority Data
Feb. 1, 2002 (JP) 2002-025221

(51) Int. Cl. G06F 15/16

(52) U.S. Cl. 709/228

(57) ABSTRACT

In case a telephone number of a first terminal is changed a second terminal in which the telephone number or mail address of this first terminal before the change is registered in its address book is connected to a server for communication with other party, the new telephone number or mail address of the first terminal are notified to the second terminal with permission of the user of the first terminal.

### BACKGROUND OF THE INVENTION

1. Field of the Invention

The present invention relates to a terminal information management method for managing telephone numbers or mail addresses of a wide variety of mobile terminals, such as portable telephones or the like.

2. Description of the Prior Art

Recently there has been something of a boom in portable telephone systems, and the portable telephone market has seen the continual introduction of new models offering new and improved functions. This makes the useful life of a portable telephone extremely short and it is common practice for users to purchase a new phone to change from the old model they have been using to the latest model. When changing to the new model, if the user does not change the communications company they have an agreement with, it is possible to carry on using the telephone number and mail address they have been using with the old telephone. That is, the telephone number and mail address used with the old telephone are registered as the telephone number and mail address for the new telephone. On the contrary, if the communications company is changed when changing to a new telephone, it is not possible to continue using the telephone number and mail address of the old telephone. That is, at the time of changing the telephone, a telephone number and mail address that are different from those of the old telephone are assigned to the new telephone.

Now, a lot of users register telephone numbers and mail addresses of people they call frequently in an electronic address book provided in a storage section of the portable telephone. A service has been proposed, when changing telephones, to use this electronic address book to automatically notify people whose telephone numbers or mail address are stored in the address book that the telephone number and mail address of the user have changed. With this service, the people receiving the notification can be made aware of the fact that the user has changed their telephone number and mail address. However, people who that do not receive the notification about the changed telephone number will not be aware that the user has changed their telephone number and mail address. In other words, people other than those whose telephone numbers or mail addresses are registered in the electronic address book of the user changing telephones will not be notified of the change, which means that those people can not be made aware of the change in the user's telephone number and mail address. Nevertheless, notifying a change of user's telephone number and mail address to everyone is not preferable because there is a high possibility of the user then receiving malicious phone calls or junk mail.

### SUMMARY OF THE INVENTION

The object of the present invention is to provide a terminal information management method capable of notifying change of telephone number and mail address, that is, information designating a mobile terminal, such as a portable telephone, to users not registered in an electronic address book of the mobile terminal, as well as to users that are registered in the address book.

A first aspect of a terminal information management method of the present invention is to execute the following plurality of steps on a server computer capable of communication with a plurality of terminals respectively assigned terminal designation information for identifying themselves. A first step is a registering step executed, when terminal designation information of a terminal is changed, to register the terminal designation information of the terminal before the change and those after the change in an update table with them associated with each other. A second step is an address book acquisition step for acquiring an address book table individually stored in each terminal and registered with terminal designation information for other terminals. A third step is a notification step executed, when terminal designation information for other terminals registered in an address book table acquired in the address book acquisition step is registered in the update table as terminal designation information before the change, notifying terminal designation information after the change associated with the terminal designation information before the change to the terminal storing the address book table.

With this type of arrangement, when a particular user changes their terminal designation information, it is possible to notify the terminal designation information after the change to all terminals having this terminal designation information stored in their address book table.

A second aspect of a terminal information management method of the present invention is to execute on a server computer in addition to the above described steps, a determination step for determining whether or not it is possible to notify the terminal designation information after the change associated with the terminal information before the change to a terminal storing the address book table, when the terminal designation information for other terminals registered in the address book table acquired in the address book acquisition steps is registered in the update table as terminal designation information before the change and to execute the notification step only if it is determined in the determination step that notification is possible.

With this type of arrangement, the terminal designation information after the change is notified to terminals storing the address book table only if it has been determined in the determination step that notification is possible, so that it is possible to prevent terminal designation information from being notified to people the user does not want to notify.

### BRIEF DESCRIPTION OF THE DRAWINGS

The invention will be described below in detail with reference to the accompanying drawings, in which:

FIG. 1 is a schematic drawing showing the overall structure of a communication system of an embodiment of the present invention;

FIG. 2 is a block diagram schematically showing the structure of a mobile terminal;

FIG. 3 is a table showing an address book table;

FIG. 4 is a block diagram showing the structure of a server;

FIG. 5 is a table showing a user table;

FIG. 6 is a table showing an update table;

FIG. 7 is a table showing a history table;

FIG. 8 is a flowchart showing a change content storage process;

FIG. 9 is a flowchart showing a process for providing an automatic change service; and

FIG. 10 is a flowchart showing a process for determining notification propriety.

### DESCRIPTION OF THE PREFERRED EMBODIMENT

A preferred embodiment of the present invention will be described below with reference to the drawings.

Communication System

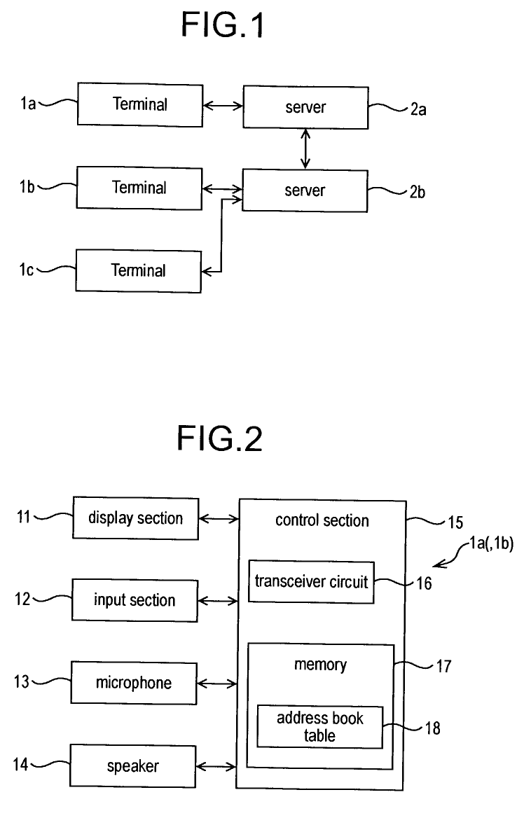

As shown in FIG. 1, mobile terminals 1a, 1b, such as portable telephones, are respectively wirelessly connected to servers 2a, 2b of a communications company that users of the mobile terminals have an agreement with, to enable communication with other telephones (fixed telephone, mobile terminal such as portable telephone etc.). The two servers 2a and 2b are used by respectively different communications companies, but they are connected to each other through communication circuits. Specifically, in a state where a first terminal 1a is connected to a first server 2a used by a first communications company and a second terminal 1b is connected to a second server 2b used by a second communications company, the two terminals 1a and 1b can communicate with each other by establishing communication between the two servers 2a and 2b.

Terminal

FIG. 2 is a block diagram schematically showing the structure of the first terminal 1a. A second terminal 1b has the same structure as the first terminal 1a.

As shown in FIG. 2, the first terminal 1a is provided with a display section 11, an input section 12, a microphone 13, a speaker 14 and a control section 15. The display section 11 has a liquid crystal display, and displays characters and images on the screen of this liquid crystal display. The input section 12 has a tenkey pad and operation keys, and receives input operations from a user therethrough. The microphone 13 and the speaker 14 can respectively input and output voices. The display section 11, input section 12, microphone 13 and speaker 14 are respectively connected to the control section 15.

The control section 15 is provided with a transceiver circuit 16 and a memory 17. The transceiver circuit 16 carries out transmission and reception of data over a wireless link. An address book table 18 is stored in the memory 17.

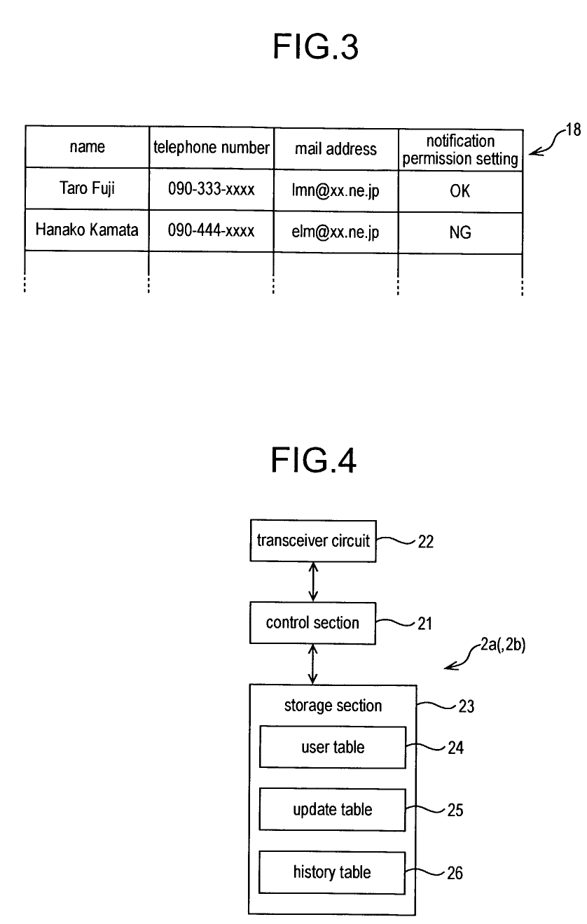

FIG. 3 is a table logically showing the address book table 18. The user can register names, telephone numbers and mail addresses of a number of people in their own terminal 1a (1b). Specifically, a single person's data is registered in the address book table 18 as a single record. When a user communicates with a registered person, the user can designate the telephone number or mail address of that person by simply selecting a desired record from the address book table 18. This address book table 18 also has a “notification permission setting” field as well as the “name”, “telephone number” and “mail address” fields. When the user's telephone number and mail address are changed, information indicating whether or not to notify the content of the change to people corresponding to the “name” fields is stored in this “notification permission” field. This notification is performed by an automatic update service that will be described later.

Also, the user's own telephone number and mail address are stored in a not-illustrated region of the memory 17 of the first terminal 1a. The first terminal 1a can communicate with the other terminal 1b through the server 2a by transmitting its own telephone address or mail address and the telephone number or mail address of the other terminal 1b selected by users from the user's address book table 18 or directly inputted through the input section 12 to the server 2a according to a specified communication protocol.

Server

FIG. 4 is a block diagram schematically showing the structure of the server 2a. This server (server computer) 2a is provided with a control section 21, a transceiver circuit 22 and a storage section 23. The control section 21 is respectively connected to the transceiver circuit 22 and the storage section 23. The transceiver circuit 22 includes a plurality of base stations distributed throughout the service area for the first terminal 1a, and carries out transmission and receipt of data to and from the terminal 1a through these base stations. The storage section 23 is, for example, a hard disk. A user table 24, update table 25 and history table 26 are stored in the storage section 23.

The second server 2b has the same structure as the first server 2a. Also, the update tables 25 respectively stored in the storage sections 23 of the two servers 2a and 2b are the same as each other. Therefore, when updating one of the update tables 25 of the two servers 2a and 2b, the other update table 25 is also updated in the same way through communication between the two servers 2a and 2b. On the contrary, the user table 24 and history table 26 stored in the storage section 23 of the second server 2b has individual data that is different from those in the first server 2a.

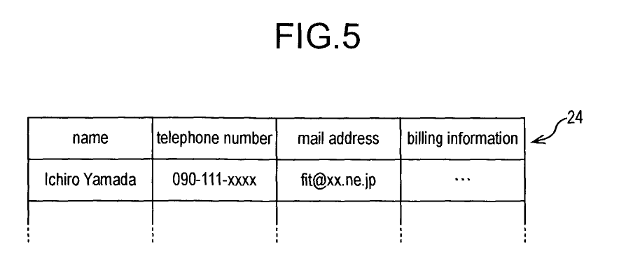

FIG. 5 is a table logically showing the user table 24. This user table 24 has a plurality of records provided for each user having an agreement with the communications company operating the server 2a. This user table 24 is provided with fields for “name”, “telephone number”, “mail address” and “billing information”.

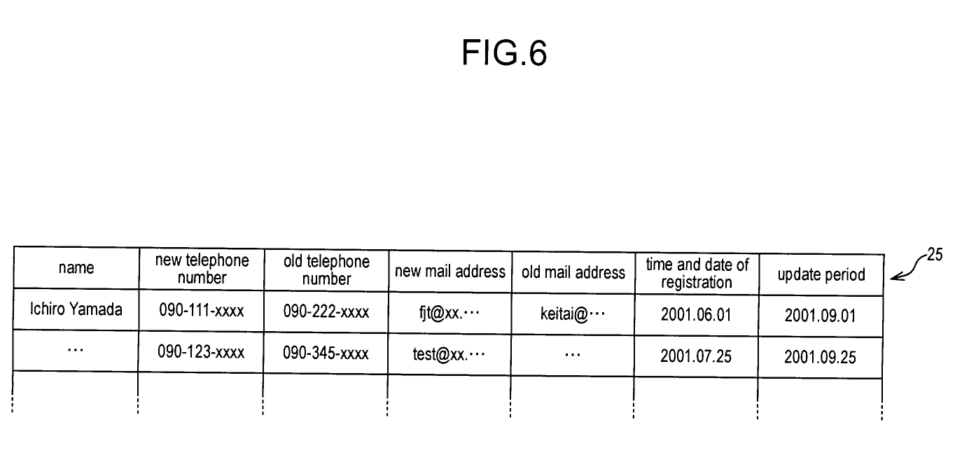

FIG. 6 is a schematic drawing logically showing the update table 25. This update table 25 has a plurality of records. When changing the telephone numbers or mail addresses owned by individual users, the detail of this change is stored in the respective records. These telephone numbers and mail addresses are generally termed terminal designation information. For example, if a user acquires a new telephone number and mail address by purchasing a new terminal 1a and abandons the telephone number and mail address for the originally used old terminal 1c, the detail of the change of the terminal designation information is added to the update table 25 as one record. Similarly, if a user have the telephone number and mail address changed by the communications company without changing the terminal itself, the detail of the change of the terminal designation information is added to the update table 25 as a single record. Each record of this update table 25 is made up of respective fields for “name”, “new telephone number”, “old telephone number”, “new mail address”, “old mail address”, “time and date of registration” and “update period”. The name of the user changing the telephone number and mail address is stored in the “name” field. Also, the user's new telephone number and old telephone number, and new mail address and old mail address are respectively stored in the “new telephone number”, “old telephone number”, “new mail address” and “old mail address” fields. The time and date when the record was created are stored in the “time and date of registration” field. The time and date of expiration of an automatic update service, which will be described later, is stored in the “update period” field.

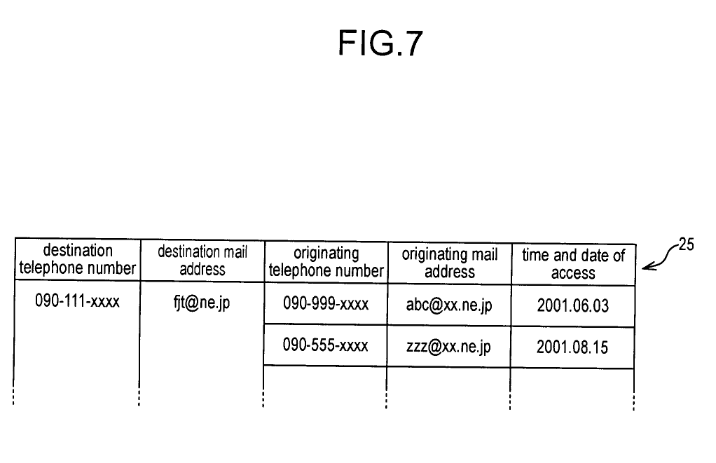

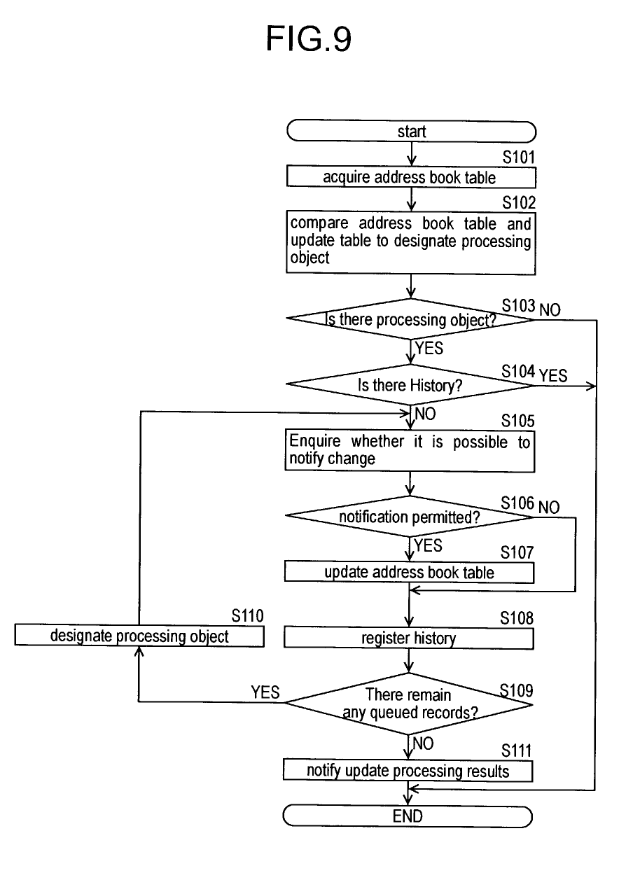

FIG. 7 is a table logically showing a history table 26. This history table 26 is made up of “destination telephone number”, “destination mail address”, “originating telephone number”, “originating mail address”, and “time and date of access” fields. The telephone number and mail address of a terminal 1a actually being used by a user receiving the automatic update service, described later, are respectively store in the “destination telephone number” and “destination mail address” fields. The telephone numbers and mail addresses of people (call originators) who register, in the address book table 18 of their own terminal 1b, information of a user having the terminal 1a of which telephone number and mail address are stored in the “destination telephone number” field and “destination mail address” field as a call destination are respectively stored in the corresponding “originating telephone number” field and “originating mail address” field. The time and date when the call originator is in communication with an arbitrary party based on a call made by the call originator is stored in the “time and date of access” field. Records in this history table 26 are created in a process of S108 in FIG. 9, which will be described later.

Automatic Update Service

In the event that a user's telephone number or mail address is changed (from those of an old terminal 1c to those of a new terminal 1a, or without changing the terminal 1a itself), it is possible to pay for use of an automatic update service by registering the detail of the change in the server 2a of the communications company. The automatic update service is to notify, when the telephone number or mail address owned by a user have been changed, the detail of the change to another terminal 1b of another person having the telephone number or mail address of the user registered in the address book table 18 in advance.

The following description will be given assuming a case where a particular user has canceled an agreement they have held with a communications company (here it is the second communications company described above) up to now because of the purchase of a new terminal 1a, and made a new agreement with the above described first communications company, and therefore his or her telephone number and mail address have been changed because of replacement of agreements.

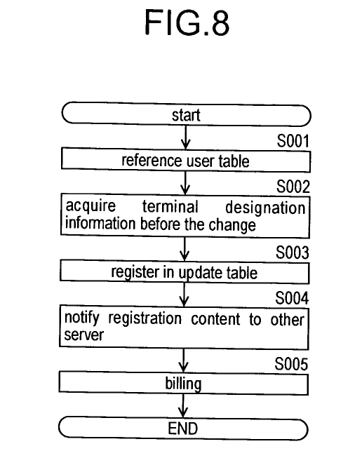

FIG. 8 is a flowchart showing a change registration process. If the user connects their own terminal 1a to the server 2a to transmit a specified command to apply for an automatic update service, this server 2a starts the process according to the flowchart of FIG. 8. The terminal 1a notifies its own telephone number to the server 2a when connected to the server 2a. Accordingly, the server 2a can ascertain the telephone number of the terminal 1a connected thereto.

In the first step S001 after starting the process of FIG. 8, the server 2a references the user table 24 and specifies records containing the telephone number of the connected terminal 1a.

In the next step S002, the server 2a acquires old terminal designation information before the change. Specifically, the server 2a displays guidance to prompt the user to input the old telephone number and old mail address before the change on the display section 11 of the terminal 1a. If the user inputs a telephone number and mail address by operating the input section 12 of the terminal 1a in accordance with this guidance, the input information is notified to the server 2a as the old terminal designation information before the change. The guidance can also be audio guidance output from the speaker 14.

In the next step S003, the server 2a registers a new record in the update table 25. Specifically, the server 2a respectively stores the contents of each of the “name”, “telephone number” and “mail address” fields of the records in the user table 24 designated in step S001 into each of the “name”, “new telephone number” and “new mail address” of the new registered record in the update table 25. The server 2a also respectively stores the old telephone number and old mail address before the change acquired in step S002 into the “old telephone number” and “old mail address” fields of the new record in the update table 25. The time and date when the new record was registered is stored into the “time and date of registration” field of the new record in the update table 25. The time and date after a specified service period has elapsed from the “time and date of registration” is stored into the “update period” of the new record of the update table 25.

In the next step S004, the server 2a notifies the new record of the update table 25 to another server 2b operated by the communications company corresponding to the old telephone number before the change acquired in step S002. Then, the server 2b adds the new record to its own update table 25. Therefore, the update tables 25 of the servers 2a and 2b are always kept the same as each other. The server 2a skips step S004 in the event that the old telephone number before the change corresponds to the communications company operating itself.

In step S005, the server 2a registers the cost of the automatic update service in the “billing information” field of the record designated in step S001 in the user table 24, and processing is completed. By paying this amount, the user can receive the automatic update service for the period of time from the “time and date of registration” up to the “update period” stored in the new record in the update table 25.

Each of the servers 2a and 2b periodically executes processing to delete records whose “update period” has expired from the update table 25. As a result, only records whose “update period” has not expired are contained in the update table 25.

If a record for the user of the terminal 1a is registered in the update table 25 through the processing of the flowchart of FIG. 8 described above, the automatic update service is provided to the terminal 1a until the “update period” of that record expires. Specifically, when the second terminal 1b accesses the server 2b after the record for the terminal 1a has been registered in the update table 25, the server 2b provides the automatic update service by starting the processing according to the flowchart of FIG. 9. In the event that the server 2b is accessed by the terminal 1b in order to establish a call (communication) with an arbitrary party, the server 2 establishes a call requested by the terminal 1b and executes the processing of the flowchart of FIG. 9 while processing the call.

In the first step S101 after starting process of FIG. 9, the server 2b requests an address book table 18 from the accessing terminal 1b, and acquires this address book table 18.

In the next step S102, the server 2b compares the address book table 18 of the terminal 1b acquired in S101 with the update table 25. Specifically, if, among the respective records of the address book table 18 of the terminal 1b, there are records containing a “telephone number” field or “mail address” field that has the same value as an “old telephone number” field or “old mail address” field of any record in the update table 25, the server 2b extracts all such records as queued records and designates one of the queued records as an object of processing.

In the next step S103, the server 2b checks whether or not it could to designate a processing object record in the address book table 18 of the terminal 1b through the processing of step S102. If a processing object record has been found, processing advances to step S104, otherwise processing terminates.

In step S104, the server 2b references the history table 26 and checks whether or not there are any records in the history table 26, of which values in the “destination telephone number” field or “destination mail address” field match with values of the “telephone number” field or “mail address” field of the processing object record, and of which values in the “originating telephone number” field or “originating mail address” field match with the telephone number or mail address of the terminal 1b. If there are any records satisfying those conditions, it is determined that there is a history and processing terminates, otherwise processing proceeds to step S105.

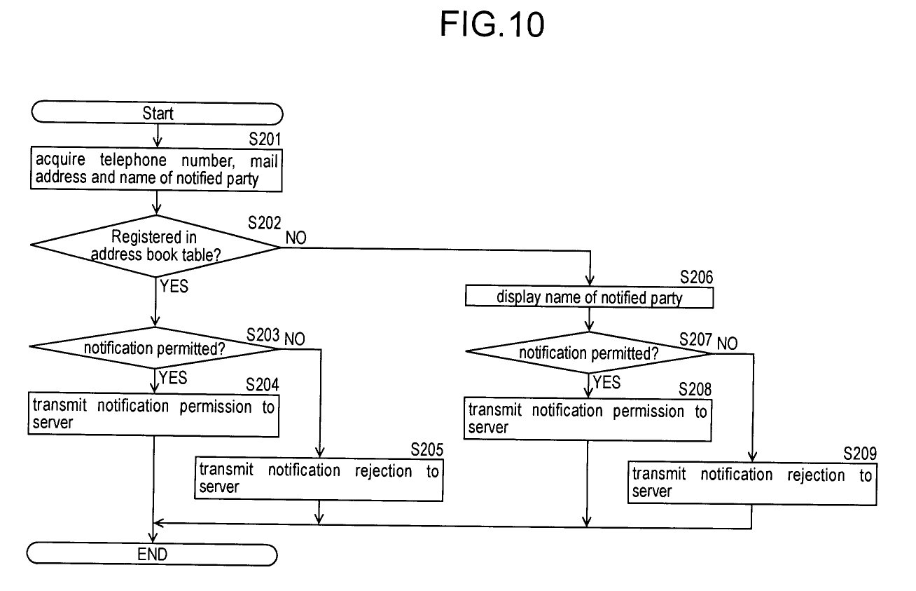

In step S105, the server 2b communicates with the terminal 1a assigned values of the “telephone number” field of the processing object record, and enquires, from the terminal 1a, whether or not it is possible to notify change of a telephone number or mail address of the terminal 1a to the terminal 1b. Then, the terminal 1a returns permission or rejection of the notification to the server 2b by automatically executing processing that will be described later with reference to FIG. 10.

In step S106, if the server 2b receives the permission of the notification through the processing of step S105, processing advances to step S107, otherwise processing advances to step S108.

In step S107, the server 2b updates the address book table 18 of the terminal 1b. Specifically, the server 2b makes the terminal 1b write values of the “new telephone number” field and the “new mail address” field of the record in the update table 25 of which values of the “old telephone number” field or “old mail address” field match with the values of “telephone number” field or the “mail address” field of the processing object record over the “telephone number” field and “mail address” field of the processing object record in the address book table 18 of the terminal 1b, by communicating with the server 1b to activate a data update program previously stored in the terminal 1b.

In step S108, the server 2b adds a new record to the history table 26. Specifically, the server 2b creates a record of which “destination telephone number” field and “destination mail address” field are stored with values of the “telephone number” field and “mail address” field of the processing object record respectively, and of which “originating telephone number” field and “originating mail address” field are stored with the telephone number and mail address of the terminal 1b respectively, and registers this record in the history table 26. The data and time that the new record was created is stored in “access time and date” field of this new created record. If registration in this history table 26 is completed the processing object record becomes managed as a processed record.

In the next step S109, the server 2b checks whether or not there remain any queued records that are not processed. If there are still remain any queued records that are not processed, processing advances to step S110.

In step S110, the server 2b designates unprocessed one of the queued record as new processing object record, and processing immediately returns to step S104. Conversely, if it is determined in step S109 that all of the queued records have become processed as a result of repeatedly execution of the processing loop from steps S104 to step S110 described above, the server 2b advances the processing to step S111.

In step S111, the server 2b makes the terminal 16 display processing results on its display section 11. Specifically, if the address book table was updated in step S107, the content of this update is displayed. After displaying the update content, processing is terminated. The server 2b maintains the connection with the terminal 1b even after termination of the processing of FIG. 9. After that, the user of the terminal 1b terminates connection between the terminal 1b and the server 2b at a point in time when a desired call is terminated. After termination of the call, the user can ascertain the processing results by looking at the display section 11 of the terminal 1b.

FIG. 10 is a flowchart showing a process for determining permission or rejection of notification executed on the terminal 1a. When the server 2b enquires whether or not it is permitted to notify change of telephone number or mail address of the terminal 1a to the terminal 1b notified party) in the above described step S105 in FIG. 9, the terminal 1a activates a previously installed program to start the processing shown in the flowchart of FIG. 10.

In the first step S201 after starting the process, the terminal 1a acquires the telephone number, mail address and the user name of the terminal 1b of the notified party from the server 2b.

In the next step S202, the terminal la references its own address book table 18 and determines whether or not the telephone number or mail address of the notified party acquired in step S201 are registered in this address book table 18. The terminal 1a then advances processing to step S203 if the telephone number or mail address is registered, and if not processing advances to step S206.

In step S203, the terminal 1a designates, from among records of its own address book table 18, a record that includes the telephone number or mail address of the notified party acquired in step S201, and if the content of a “notification permission setting” field in the designated record is ‘OK’, determines that notification is permitted to advance processing to step S204, while if the content of this “notification permission setting” field is NG, determines that notification is rejected to advance processing to step S205.

In step S204, the terminal 1a notifies the server 2b of the fact that to notification of its own telephone number and mail address to the terminal 1b is permitted via the server 2a, and then terminates processing.

In step S205, the terminal 1a notifies the server 2b of the fact that notification of its own telephone number and mail address to the terminal 1b is rejected via the server 2a, and then terminates processing.

In step S206, the terminal displays the name of the user owning the terminal 1b of the notified party acquired in step S201 on its display section 11. The user looks at this displayed name to decide whether he or she permits notification of their own new telephone number and new mail address to the terminal 1b of the notified party, and inputs the result of this decision to the input section 12.

In the next step S207, the terminal 1a advances processing to step S208 if the user inputs the fact that the notification is permitted in step S206, and otherwise advances to step S209.

In step S208, the terminal 1a notifies server 2b of the fact that notification of its own new telephone number and new mail address to the terminal 1b is permitted the via the server 2a, and then terminates processing.

In step S209, the terminal 1a notifies the server 2b of the fact that notification of its own new telephone number and new mail address to the terminal 1b is rejected via the server 2a, and then terminates processing.

As described above, according to the automatic update service, when a terminal 1b registering an old telephone number or old mail address owned by a particular user in its address book table 18 accesses the server 2b, the terminal 1b is automatically or substantially automatically notified of a new telephone number and new mail address of new terminal 1a owned by that user. Accordingly, effort involved for the user with change of the telephone number or mail address is reduced. For this reason, when purchasing a new model of a terminal, a user can freely select a communications company without worrying about changing of his or her telephone number or mail address. Additionally, in this automatic update service, the new telephone number and new mail address are notified only to people whom the user permits to be notified, which makes possible to prevent such disadvantages as malicious calls or junk mail.

With the terminal information management method of the present invention having the above described configuration, in the event that terminal designation information of other terminals registered in an address book table of a terminal becomes unusable because of change of the terminal designation information, new terminal designation information is notified to the terminal storing the address book table. Accordingly, effort involved for the user with change of the terminal designation information is reduced.

We claim:

1. A terminal information management method, executed on a server computer capable of communication with a plurality of terminals respectively assigned terminal designation information for identifying themselves, comprising:
a registering step for, when terminal designation information of a terminal is changed, registering the terminal designation information of the terminal before the change and those after the change in an update table stored in a storage medium with them associated with each other;
an address book acquisition step for acquiring an address book table individually stored in each terminal and registered with terminal designation information for other terminals; and
a notification step for, when terminal designation information for other terminals registered in an address book table acquired in the address book acquisition step is registered in the update table as terminal designation information before the change, notifying terminal designation information after the change associated with the terminal designation information before the change to, the terminal storing the address book table.

2. The terminal information management method according to claim 1, further comprising:
a determination step for, when the terminal designation information for other terminals registered in the address book table acquired in the address book acquisition step is registered in the update table as terminal designation information before the change, determining whether or not it is possible to notify the terminal designation information after the change associated with the terminal designation information before the change to the terminal storing the address book table, and
wherein said notification step is executed only if it is determined in the determination step that notification is possible.

3. The terminal information management method according to claim 2, wherein
in the determination step, it is determined by enquiring whether the notification is possible from the terminal corresponding to the terminal designation information before the change.

4. The terminal information management method of claim 2, wherein
in the determination step, it is determined that notification is permitted if the terminal corresponding to the terminal designation information before the change is previously registered with notification permission information which represents permission of the notification.

5. The terminal information management method of claim 2, further comprising
a history recording step for recording a history of execution of the determination step with respect to other terminals registered in the address book table, and
wherein said determination step is executed only if there is not history of execution with respect to other terminals registered in the address book table.

6. The terminal information management method of claim 1, wherein
the address book acquisition step is executed when the terminal accesses the server computer.

7. A terminal information management program, read in to a computer capable of communicating with a plurality of terminals respectively assigned terminal designation information for identifying themselves, making the computer execute:
a registering step for, when terminal designation information of a terminal is changed, registering terminal designation information before the change and those after the change, in an update table stored in a storage medium with them associated with each other;
an address book acquisition step for acquiring an address book table individually stored in each terminal and registered with terminal designation information for other terminals; and
a notification step for, when terminal designation information for other terminals registered in an address book table acquired in the address book acquisition step is registered in the update table as terminal designation information before the change, notifying terminal designation information after the change associated with the terminal designation information before the change to the terminal storing the address book table.

8. A server computer capable of communicating with a plurality of terminals respectively assigned terminal designation information for identifying themselves, having a storage medium and a processing device, a program stored in the storage medium making the processing device execute steps of:
registering, when terminal designation information of a terminal is changed, terminal designation information before the change with terminal designation information after the change in an update table stored in a storage medium, with them associated with each other,
acquiring an address book table individually stored in each terminal and registered with terminal designation information for other terminals, and
notifying, when terminal designation information for other terminals registered in the address book table is registered in the update table as terminal designation information before change, terminal designation information after the change associated with the terminal designation information before the change to the terminal storing the address book table
